(19) United States
(12) Patent Application Publication
(10) Pub. No.: US 2004/0196477 A1
(43) Pub. Date: Oct. 7, 2004

(54) Imaging means for excisions apparatus

(76) Inventors: Edmond Joseph Breen, Berora (AU); Ronald Jones, Ashfield (AU)

Correspondence Address: BOZICEVIC, FIELD & FRANCIS LLP, 200 MIDDLEFIELD RD, SUITE 200, MENLO PARK, CA, 94025, US

(21) Appl. No.: 10/479,018

(22) PCT Filed: May 27, 2002
(86) PCT No.: PCT/AU02/00656

(30) Foreign Application Priority Data
May 25, 2001 (AU) PR 5226

(51) Int. Cl. G06F 15/00; H04N 1/46

(52) U.S. Cl. 358/1.9; 358/504; 358/1.8

(57) ABSTRACT

A scanner including a glass plate under which a scanning head moves on rails forms part of an integrated automated gel excision and sample processing apparatus which includes a moveable machine head mounted for movement in X and Y directions along an X axis and Y axis. A cutting head is mounted for movement up and down a vertical Z Axis. A series of four crosses (22) known as “fiducials” are defined at each corner of the glass plate on the underside so that they superpose onto the scanned image of a gel on the plate. The scanned image thus includes reference points for the spots in the array. A grey scale card (24) is scanned along with the image of the gel whose luminance is known and has known reflection densities that can be applied to each colour in the image, red green blue etc and used to work out the intensity of each spot in the array so that absolute intensity values can be compared from image to image and scanner to scanner. The apparatus further includes the steps of for a least one spot in the array, defining the optimal work area for working in, and in particular the optimal place to cut one spot out from the gel without affecting neighbouring spots.

### FIELD OF THE INVENTION

This invention relates to an imaging means for an excision apparatus.

### BACKGROUND OF THE INVENTION

Desktop scanners are popular and relatively cheap accessories for computers which are used to convert photographs and documents or the like into electronic form. Most desktop scanners include a glass sheet on which the object to be scanned is placed. Underneath that glass sheet there is a scanning head which scans the object through the glass whilst being driven along a rail or pair of rails, by a belt drive or the like, typically one which uses a toothed rubber belt. However, over time the toothed rubber belt tends to stretch and the accuracy of the scanner deteriorates. Even when new, the accuracy of desktop scanners is not good. If the same picture was scanned several times on a desktop scanner, the location of the features in the picture, would typically move by plus or minus 9 pixels, for a typical scanner having a resolution of between 300 and 600 dpi.

Although the above are not necessarily problems when the scanner is simply being used to scan pictures or text for storage on the computer, problems arise if the scanner is being used analytically, where locations of various objects in the scanned image, needs to be precisely known.

For these uses, desktop scanners are unsuitable and more expensive analytical scanners have to be purchased.

A second problem which arises with scanners is the problem of comparing an image scanned on one scanner, with an image scanned on a different scanner, where the intensity values of the scanned images may differ.

Specific aspects of the present invention are concerned with the utilisation of information gathered from scans of images, particularly images of two dimensional arrays of biomolecules, either in a gel or arrayed on a solid support, the use of that information to enable manipulation and treatment of those spots.

Co-pending international patent applications “Liquid handling means for excision apparatus” and “Sample collection and preparation apparatus” filed 27 May 2002, in the names of Proteome Systems Ltd and Shimadzu Corporation, the contents of which are incorporated herein by reference, describe an automatic robotic apparatus for excising spots from gels and processing the same for MALDI analysis. This invention relates to a scanner which may be used in such an apparatus.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

### SUMMARY OF THE INVENTION

In a first broad aspect, the present invention provides a method for use in controlling a cutting head of an automated cutting apparatus for excising a sample in the form of a spot from a generally planar array of samples including the steps of:

using an image capture means to obtain an electronic image of the array;

for a least one spot in the captured electronic image of the array defining the optimal area to work in within the edge boundaries of that spot;

creating a boundary around said optimal area; and

using information about the neighbourhood of the spot to refine the optimal area.

Typically, the calibration strip is a grey scale strip, each component of the array can be viewed as a grey scale image, and absolute intensity values can be compared from image to image and scanner to scanner.

The absolute intensity values of the spots on the array, are then utilised in the method of the present invention to determine how much reagent to deposit on each spot in the further processing of the array, or to determine in which order the spots in the array are to be treated. The provision of absolute intensity values allows more accurate deposition of reagents on the spots more accurately depending on the density of the spot, which is proportionate to the quantity of material present in the spot.

The use of absolute intensities also allows cut-offs to be applied during the processing of the array. For example, processing can be carried out at the basis of spots having a particular intensity being processed in one way and spots in the array having a lesser intensity being processed in a different way. For example, there may be a “cut-off” value of optical density below which a more expensive “zip top”, incorporating a resin is used to treat an excised spot, rather than a standard tip.

A further advantage is that the amount of trypsin or other enzyme required to digest the spot (typically a protein) into peptides can be accurately determined. When MALDI-TOF analysis is subsequently carried out on the digested protein, any excess trypsin suppresses the signals generated by the peptides, hence using the minimum quantity of trypsin improves the results of the MALDI-TOF analysis.

A second aspect of the present invention relates to the processing of adjacent spots and in particular relates to the further processing of spots in an array which takes account of the relative location of the spots in the array.

Broadly the invention includes the steps of, for a least one spot in the array, defining the optimal areas to work in within the boundaries of that spot and creating a boundary around that optimal area and using information about the neighbourhood of the spot, such as the location of adjacent spots to refine the optimal area.

The step of picking out the best area for working in, might be based on the intensity of the spot. For example, the optimal working area of the spot might be those areas of the spot for which the intensity is at least 90% of the most intense part of the spot.

“Working” in a particular area may include cutting out a spot or depositing reagents on a spot. The step of depositing reagents on a spot may be carried out using the printer of AU 722578, the contents of which are incorporated herein by reference.

The method takes account of the size of the cutting tool head ie. Its footprint or the size of the spot it typically occupies. It also takes account of the size of the spot itself.

Typically the use of the neighbourhood information to refine areas, will encourage the treatment of a particular spot to occur as far apart as possible from an adjacent spot.

The information may also be used to determine which order the various spots in the array should be treated.

This is particularly important if the array is an array of spots in a gel and a spot is to be excised from the gel by a process in which the gel is pierced and the spot sucked up using a cutting tool. Where such a cut is made close to the edge of the gel, whether that is the boundary of the array or an edge where a spot has previously been cut out, cutting is difficult and the gel can often shatter.

### BRIEF DESCRIPTION OF THE DRAWINGS

Specific embodiments of the invention will now be described, by way of example only, and with reference to the accompanying drawings in which:

FIG. 1 shows a gel excision and processing apparatus with certain components removed to show a scanner;

FIG. 2 is a schematic side view of an analytical scanner;

FIG. 3 is a schematic diagram of two adjacent spots of an array on which is superposed the cutting footprint of a cutting tool;

FIG. 4 shows the same spots as FIG. 3 in which the cutting footprint has been moved;

FIG. 5 is a graph illustrating the variations in intensity across a spot; and

FIG. 6 illustrates calibration of the scanner.

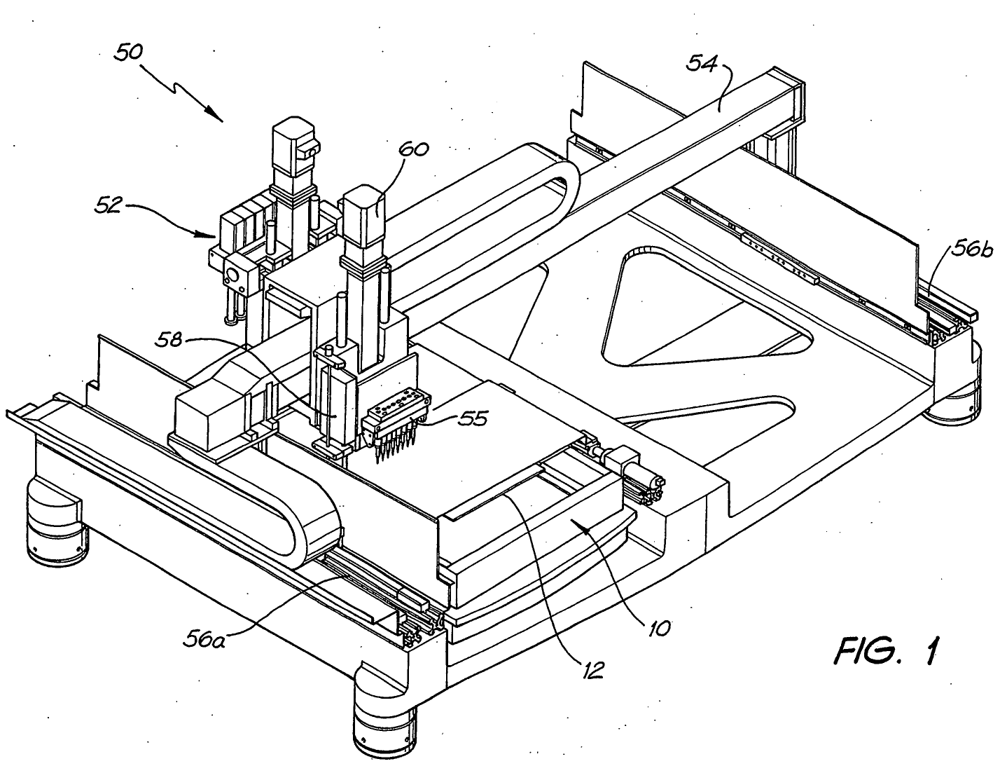

### DETAILED DESCRIPTION OF A PREFERRED EMBODIMENT

Referring to the drawings, FIG. 2 shows a scanner generally indicated at 10 in the form of a box-like container or body whose top defines a transparent glass plate 12 on top of which rests a sheet of gel 14. Inside the body there is a scanning head 16 which scans the underside of the gel through the glass plate 12. The scan may be carried out in a reflective mode in which the light source illuminating the gel is located on the same side of the glass as the scanning head, or in transmissive mode in which case the light source is on the opposite side of the gel and the scan records light which has passed through the gel. The scanning head runs along rails 18 attached to the scanner's electronics and control means by a flexible cable 18. FIGS. 2 and 6 show a series of four crosses 22 known as “fiducials” one near each corner of the glass plate 12 which are defined on the underside of the plate so that they are superposed onto the scanned image of the gel. The scanned image thus includes reference points for the spots in the array.

The scanner 10 forms part of an integrated automated gel excision and sample processing apparatus 50 which includes a moveable machine head 52 mounted for movement in X and Y directions along X axis 54 and Y axis 56a, 56b. A cutting head 58 is mounted for movement up and down a vertical Z Axis 60. The apparatus also includes a liquid delivery means 55.

FIG. 6 illustrates a second feature of the invention being a grey scale card 24 which is scanned along with the image of the gel whose luminance is known and which has known reflection densities That can be applied to each colour in the image, red green blue etc, and used to work out the intensity of each spot in the array so that absolute intensity values can be compared from image to image and scanner to scanner.

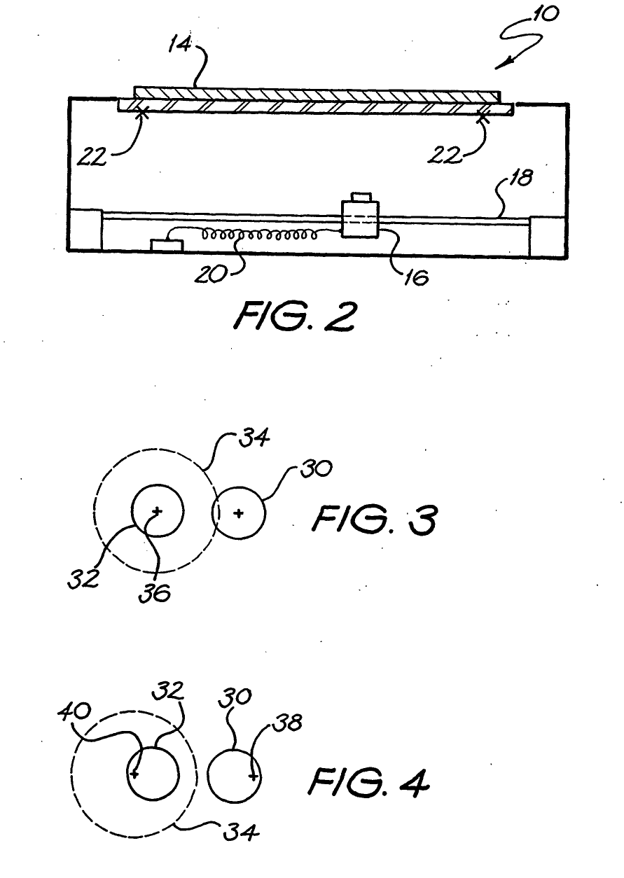

The third problem the present invention addresses is the problem of the closeness of adjacent spots when those spots are to be treated, cut by a cutting tool or the like. FIG. 3 show two adjacent 30, 32 of an array on which is superposed the cutting footprint 34 of a cutting tool which is typically circular. The particular type of cutting tool used to cut the gel is unimportant. If the cutting tool cuts spot 32 based on the centre 36 the spot, it will also cut a part of spot 30 and contaminate the excision. Further it will create an edge near/in spot 30. Cutting near an edge of the gel is difficult and it will make it difficult to cut out spot 30. Most cutting tools pierce the gel and suck up the spot. If this occurs close to the edge of the gel, the gel can shatter outwards and make cutting difficult.

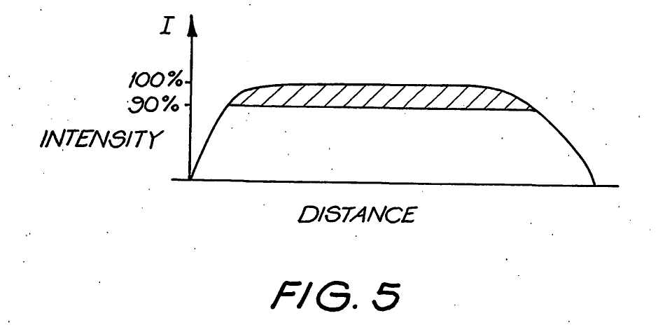

FIG. 4 shows how the control system of the present invention can be used to analyse the distance between the spots, the shape of the spots, and the size of the cutting tool head to maximise the distance apart of the cuts excising the spots. Thus the centre of the cut 40 for spot 32 is moved to the edge of spot 32 distal from spot 30 where the cut does not impact on spot 30 and contaminate the excised portion of the spot 32 with part of spot 30. Likewise the centre 38 of the cut for spot 30 is moved to the side of that spot distal from spot 32. Typically the analysis will be carried out on the basis of the shape of the spot however optionally the calculations can be weighted with information about the intensity of the spot.

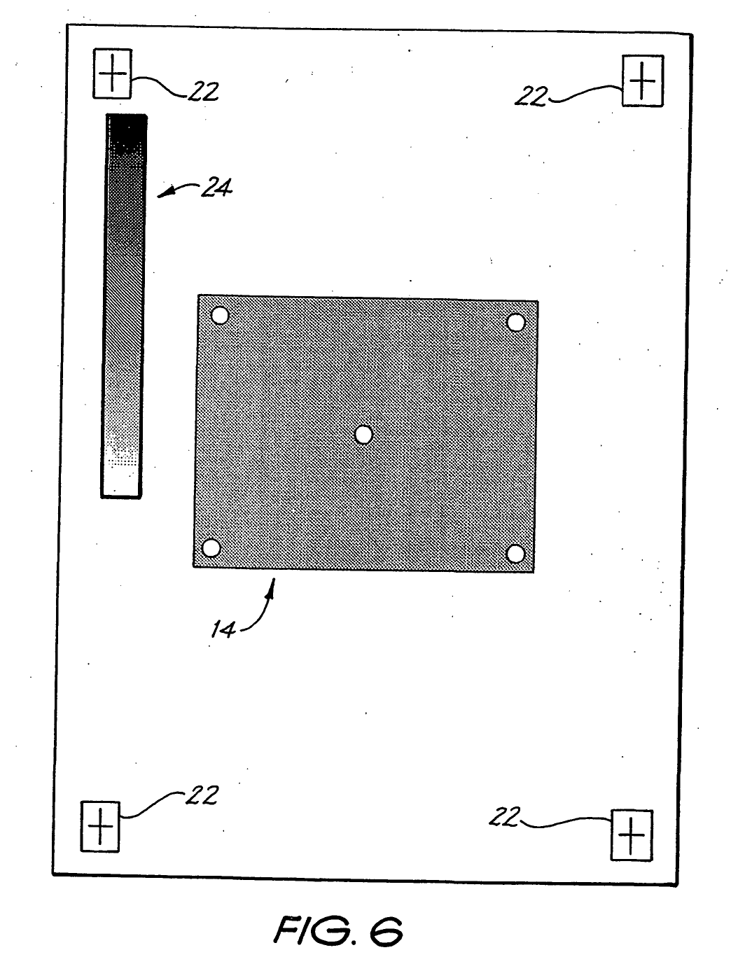

For example, FIG. 5 is a graph illustrating the variations in intensity across a spot. If the cutting tool is only to make a cut in that one spot and there are no other spots nearby, the control system may pick out the best area for working in as being that area where the intensity of the spot is at least 90% ie. where the spot is most concentrated.

Intensity information may also be used where two or more spots are close together to determine the optimal area for moving/working in.

Set out below are algorithms for calibrating the luminosity of the image of the gel 14, for “segmentation” for locating the centres of spots in images of gels, and for detecting the spatial position of the gel 14 on the scanner using the fiducial markers 22.

Luminosity

PURPOSE: Calibrate the luminosity of the image to standardise it across platforms and over time

INPUT IMAGE: Entire scanned surface, including the gel, the fiducial markers and the calibration strip

OUTPUT IMAGE: Image of gel with calibrated luminosity

S=A subset of the input image which contains the greyscale calibration swatch

F=Mean filtering of the image ‘S’ using a square mean filter of specified size

Generate a Look Up Table (LUT) Ln for each component Fn of the image ‘F’, where n=1,2,3:

Fn=The nth component of the image ‘F’

Vn[ ]=A set of N greyscales, where N is the number of swatch blocks in the swatch image ‘F’

and Vn[i] is the greyscale at the centre of the i'th block in ‘Fn’

VO[ ]=A set of N mapping values, where VO[i]=i*255/N

Construct the LUT Ln such that:

$$\begin{matrix}Ln [ j ] = ( ( j - Vn [ i ] ) / ( Vn [ i + 1 ] - Vn [ i ] ) ) * 255 / N + VO [ i ] , \\ for Vn [ i ] <= j <= Vn [ i + 1 ] \\ = 0 for j < Vn [ 1 ] \\ = 255 for j > Vn [ N ]\end{matrix}$$

I=(R,G,B)=Subset of the input image which contains only the gel

Output=The colour image (RO, GO, BO), where:

RO=LUT mapping of ‘R’ through L1

GO=LUT mapping of ‘G’ through L2

BO=LUT mapping of ‘B’ through L3

Segmentation Text

PURPOSE: Locate the centres of spots in images of gels

INPUT IMAGE: Image of gel with calibrated luminosity

OUTPUT: A file containing the (x,y) centroid coordinates of spots found in the input image

Construct a greyscale image ‘input’ from a 3 component colour image R (red), G (green), B (blue):

If the gel is a coomassie blue stain gel: I=B−(R+G)/2

Otherwise: input=255−(R+G)/2

Construct a top hat image ‘tophat’ to remove the background from the image

O=Morphologically opening of the image ‘input’ using a 12 sided polygon

tophat=input−O

Construct a seed image ‘markers’ of spot markers

O=Morphologically opening of the image ‘tophat’ using a small rectangle

R=Regional maxima in the image O with 8-connectivity

B=R>t, where t is a specified threshold

G=B*R*c, where c is a specified constant

R2=Morphological reconstruction by dilation of R (reference) using G (seeds) with 8-connectivity

D=R−R2

B2=D>t2, where t2 is a specified threshold

markers=Binary reconstruction of B2 (reference) using B (seeds) with 8-connectivity

Construct an image ‘background’ of the background pixels

B=Binary image of pixels that are within a specified distance of the edge of the image ‘input’

B2=Binary threshold of image ‘input’ using Kittler and Illingworth method of thresholding

background=Pixelwise OR of image B and B2

Construct a seed image ‘seeds’ by filtering and labelling the image ‘markers’

B=Pixelwise AND of image ‘markers’ and the inverse of the ‘background’ image

O=Morphological area opening of objects in B to remove small objects

seeds=Binary reconstruction of ‘markers’ (reference) using O (seeds) with 8-connectivity

Label and compute the centre points of the objects in the image ‘seeds’

L=label objects in ‘seeds’ using 8 connectivity

C=centroids of the objects in L

Output is the centroids, which have been processed so that they are a specified minimum distance apart and

lie within the objects in the image ‘seeds’

Spatial

PURPOSE: Find the four fiducial markers and record their centroids

INPUT IMAGE: Entire scanned surface, including the gel, the fiducial markers and the calibration strip

OUTPUT: Centroid of each fiducial marker

For each fiducial marker, compute:

S=Subset of the input image large enough to contain the fiducial marker

C=Morphologically closing of ‘S’ using a rectangle of given size

D=C−S

V=Linear opening of image D using a vertical line of given length

H=Linear opening of image D using a horizontal line of given length

M=Pixelwise minimum of the images V and H

B=M>t, where t is a specified threshold

L=Labelling of the spots in ‘B’ using 8 connectivity

C=(X,Y) centroids of the objects in L

Output=The point (X,Y) in C that is closest to the centroid of the image ‘S’.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-16. (Canceled)

17. A method for excising spots from a generally planar array of spots wherein each spot has an edge boundary and a neighbourhood, the method comprising:
obtaining an electronic image of the array;
defining an optimal work area within the edge boundary of at least one spot;
creating a boundary around the optimal work area; and
using information about the neighbourhood of the at least one spot to refine the optimal work area.

18. The method of claim 17 wherein the spots are biomolecules and the array of biomolecules is provided on a sheet of gel.

19. The method of claim 17 wherein defining an optimal work area is based on the intensity of the at least one spot.

20. The method of claim 19 wherein defining an optimal work area comprises selecting those areas of the at least one spot for which the intensity is at least 90% of the most intense part of the at least one spot.

21. The method of claim 17 further comprising excising the at least one spot from the array.

22. The method of claim 21 wherein excising the at least one spot comprises using an automated cutting apparatus.

23. The method of claim 17 further comprising depositing reagents on the at least one spot.

24. The method of claim 17 wherein using information about the neighbourhood of the at least one spot comprises using information about the location of spots adjacent the at least one spot.

25. The method of claim 17 wherein the neighbourhood of the at least one spot comprises spots adjacent the at least one spot.

26. The method of claim 25 further comprising determining a cutting footprint about the at least one spot to be excised.

27. The method of claim 26 wherein the cutting footprint does not impact adjacent spots.

28. The method of claim 26 wherein the cutting footprint does not contaminate the at least one spot to be excised.

29. The method of claim 26 further comprising determining a cutting footprint for each of two adjacent spots to be excised and moving at least one of the cutting footprints wherein the distance between the cutting footprints is maximized.

30. The method of claim 26 wherein determining a cutting footprint comprises locating the center of the at least one spot to be excised.

31. The method of claim 30 further comprising locating the center of two adjacent spots to be excised and moving at least one of the centers wherein the distance between the cutting footprints is maximized.

32. A method of scanning an array of biomolecule spots in a gel or on a solid support, the method comprising:
scanning an image of an intensity calibration strip together with an image of the array;
calculating an absolute intensity value of one or more spots in the array; and
using the calculated intensity value to further process the one or more spots in the array.

33. The method of claim 32 wherein the calibration strip is a grey scale strip.

34. The method of claim 32 further comprising using the calculated intensity value to determine how much reagent to deposit on each spot in the further processing of the array.

35. The method as claimed in claim 32 wherein the absolute intensity value is calculated for two or more spots.

36. The method of claim 35 further comprising using the calculated intensity values to determine the order in which the two or more spots are to be processed.

37. The method of claim 35 further comprising processing spots having an intensity value equal to or greater than a predetermined value in one way and processing spots having an intensity value less then the predetermined value in a different way.

38. A method of scanning an array of biomolecules in a gel or on a solid support carried on a transparent plate, the method comprising:
providing a plurality of markers in the form of crosses on the plate; and
scanning an image of the markers together with an image of the array.

39. The method of claim 38 wherein the plate is a glass plate having corners and wherein a cross is provided adjacent each of the corners.
